(19) United States
(12) Patent Application Publication
(10) Pub. No.: US 2024/0147559 A1
(43) Pub. Date: May 2, 2024

(54) APPARATUS AND METHOD FOR WIRELESS DEVICE CONNECTION

(71) Applicants: HYUNDAI MOTOR COMPANY, Soul (KR); KIA CORPORATION, Seoul (KR)

(72) Inventor: Seong Soo Yae, Hwaseong-si (KR)

(73) Assignees: HYUNDAI MOTOR COMPANY, Seoul (KR); KIA CORPORATION, Seoul (KR)

(21) Appl. No.: 18/203,346

(22) Filed: May 30, 2023

(30) Foreign Application Priority Data
Oct. 28, 2022 (KR) 10-2022-0141587

(51) Int. Cl. H04W 76/18; H04W 52/24; H04W 76/14

(52) U.S. Cl. CPC H04W 76/18; H04W 52/24; H04W 76/14

(57) ABSTRACT

An apparatus and a method for wireless device connection are disclosed. The apparatus includes a memory that stores information of a nearby device having a pairing history and a processor that monitors reception of a pairing mode operation command. The processor generates a first message to include a universal key in response to receiving the pairing mode operation command and generates a second message to include an account key of the nearby device having the pairing history when the pairing mode operation command is not received. The apparatus further includes a communication module that broadcasts the first message or the second message under control of the processor.

### CROSS-REFERENCE TO RELATED APPLICATION

This application claims the benefit of and priority to Korean Patent Application No. 10-2022-0141587, filed in the Korean Intellectual Property Office on Oct. 28, 2022, the entire contents of which are incorporated herein by reference.

### TECHNICAL FIELD

The present disclosure relates to an apparatus and method for wireless device connection, and more particularly, to a wireless connection technology between a vehicle and a nearby device.

### BACKGROUND

Vehicles provide functions for user convenience by using various convenience devices as well as providing transportation functions. For example, vehicles may include an infotainment apparatus. Infotainment is a compound word combining information and entertainment. Infotainment apparatus refers to an apparatus that provides information, audio, and visual entertainment. Because of recent advances in telematics, connected cars, and autonomous driving technologies, the role and importance of an In-Vehicle Infotainment (IVI) system is greatly increasing. For example, an IVI system may be used for informing users of vehicle information or directly controlling the vehicle beyond simple multimedia devices.

An infotainment apparatus of a vehicle may perform more diverse functions by interlocking with a nearby device such as a personal portable terminal of a user.

Although the vehicle and the nearby device are sometimes connected based on wired communication, such as a USB cable, a method of connecting through wireless communication (e.g., short-range wireless communication) is useful. A wireless connection method between the vehicle and the nearby device generally follows a procedure provided by an operating system of the nearby device.

A conventional wireless connection method between a vehicle and a nearby device has a disadvantage in that the vehicle may be connected to an unintended wireless device as a vehicle's message requesting wireless connection is sent out of the vehicle.

In addition, because the connection proceeds based on an operation of the nearby device, and a uniform method is applied, the conventional wireless connection method between the vehicle and the nearby device has a disadvantage in that active coping with various situations such as connection failure is insufficient.

### SUMMARY

The present disclosure has been made to solve the above-mentioned problems occurring in the prior art while advantages achieved by the prior art are maintained intact.

An aspect of the present disclosure provides an apparatus and method for wireless device connection capable of preventing a vehicle from being wirelessly connected to an unintended nearby device.

Another aspect of the present disclosure provides an apparatus and method for wireless device connection capable of more efficiently wirelessly connecting a vehicle and a nearby device in a non-pairing mode state.

Still another aspect of the present disclosure provides an apparatus and method for wireless device connection capable of efficiently recovering from a wireless connection failure.

Yet another aspect of the present disclosure provides an apparatus and method for wireless device connection that can more quickly connect a vehicle and a nearby device of a user even before the user boards the vehicle.

The technical problems to be solved by the present disclosure are not limited to the aforementioned problems. Any other technical problems not mentioned herein should be clearly understood from the following description by those having ordinary skill in the art to which the present disclosure pertains.

According to an aspect of the present disclosure, an apparatus for wireless device connection includes a memory that stores information of a nearby device having a pairing history. The apparatus also includes a processor that monitors reception of a pairing mode operation command. The processor generates a first message to include a universal key in response to receiving the pairing mode operation command and generates a second message to include an account key of the nearby device having the pairing history when the pairing mode operation command is not received. The apparatus further includes a communication module that broadcasts the first message or the second message under control of the processor.

According to an embodiment, the processor may control the communication module to transmit a physical address of the nearby device having the pairing history associated with an account of an operating system of the nearby device.

According to an embodiment, the processor may determine that an automatic connection attempt is being performed with respect to the nearby device. After a period of attempting the automatic connection elapses beyond a preset first period, the processor may stop the automatic connection attempt and may generate the second message.

According to an embodiment, the processor may generate the second message after determining whether there is an excess of a number of nearby devices that can be connected to a vehicle.

According to an embodiment, the processor may generate the second message based on detecting a remote control of a vehicle from a user before the user boards the vehicle.

According to an embodiment, the processor, when the connection with the nearby device fails, may perform an operation in a connectable-on mode capable of responding to a connection request from the nearby device. When there is no connection request from the nearby device for a preset second period, the processor may attempt to directly connect to the nearby device based on an address of the nearby device.

According to an embodiment, the processor may calculate a degree of attenuation based on an attenuation calculation algorithm. The processor may adjust a Tx power of a signal transferred to the nearby device through a communication module of a vehicle in proportion to the degree of attenuation and may include information on the Tx power in the first message or the second message.

According to an embodiment, the processor may adjust the degree of attenuation in proportion to a size of the vehicle.

According to an embodiment, the processor may adjust the degree of attenuation in proportion to a degree to which an interior of the vehicle is opened.

According to an embodiment, the processor may adjust the degree of attenuation in proportion to a number of passengers in the vehicle.

According to another aspect of the present disclosure, a method for wireless device connection includes monitoring reception of an operation command in a pairing mode. The method also includes broadcasting a first message including a universal key in response to receiving the operation command in the pairing mode. The method further includes broadcasting a second message including an account key of a nearby device having a pairing history when the operation command in the pairing mode is not received.

According to an embodiment, broadcasting the second message may further include transmitting a physical address of the nearby device having the pairing history associated with an account of an operating system of the nearby device.

According to an embodiment, broadcasting the second message may include determining that an automatic connection attempt is being performed with respect to the nearby device. Broadcasting the second message may further include stopping the automatic connection attempt and broadcasting the second message after a period of attempting the automatic connection elapses more than a preset first period.

According to an embodiment, broadcasting the second message may further include determining whether there is an excess of the number of nearby devices that can be connected to a vehicle.

According to an embodiment, broadcasting the second message may be performed based on detecting a remote control of a vehicle from a user before the user boards the vehicle.

According to an embodiment, broadcasting the first message or broadcasting the second message may further include performing an operation in a connectable-on mode capable of responding to a connection request from the nearby device when the connection with the nearby device fails and may include attempting to directly connect to the nearby device based on an address of the nearby device, when there is no connection request from the nearby device for a preset second period.

According to an embodiment, broadcasting the first message or broadcasting the second message may further include calculating an attenuation degree affecting wireless signal reception sensitivity of the nearby device, adjusting a Tx power of a signal transferred to the nearby device through a communication module of a vehicle in proportion to the attenuation degree, and generating the first message or the second message to further include information on the Tx power.

According to an embodiment, calculating the attenuation degree may include greatly adjusting the attenuation degree in proportion to a size of the vehicle.

According to an embodiment, calculating the attenuation degree may include greatly adjusting the attenuation degree in proportion to a degree to which an interior of the vehicle is opened.

According to an embodiment, calculating the attenuation degree may include greatly adjusting the attenuation degree in proportion to the number of passengers on the vehicle.

### BRIEF DESCRIPTION OF THE DRAWINGS

The above and other objects, features and advantages of the present disclosure should be more apparent from the following detailed description taken in conjunction with the accompanying drawings.

FIG. 1 is a block diagram illustrating a configuration of an apparatus for wireless device connection, according to an embodiment of the present disclosure.

FIG. 2 is a diagram for describing a broadcasting message, according to an embodiment of the present disclosure.

FIG. 3 is a flowchart for describing a wireless device connection method, according to an embodiment of the present disclosure.

FIG. 4 is a flowchart for describing a wireless device connection method, according to another embodiment of the present disclosure.

FIGS. 5-7 are diagrams for describing embodiments of calculating a degree of attenuation.

FIG. 8 is a flowchart for describing a wireless device connection method, according to another embodiment of the present disclosure.

FIG. 9 is a flowchart for describing a wireless device connection method, according to another embodiment of the present disclosure.

FIG. 10 is a flowchart for describing a wireless device connection method, according to another embodiment of the present disclosure.

FIG. 11 is a flowchart for describing a wireless device connection method, according to another embodiment of the present disclosure.

FIG. 12 is a diagram illustrating a computing system, according to an embodiment of the present disclosure.

### DETAILED DESCRIPTION

Hereinafter, embodiments of the present disclosure are described in detail with reference to the accompanying drawings. In the accompanying drawing, identical or equivalent components are designated by the identical numeral even when they are displayed in different drawings. Further, if it has been considered that a specific description of related known configurations or functions may cloud the gist of the present disclosure, a detailed description thereof has been omitted.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It should be further understood that terms, such as those defined in commonly used dictionaries, should be interpreted as having a meaning that is consistent with their meaning in the context of the relevant art and should not be interpreted in an idealized or overly formal sense unless expressly so defined herein.

When a component, device, element, or the like of the present disclosure is described as having a purpose or performing an operation, function, or the like, the component, device, or element should be considered herein as being “configured to” meet that purpose or perform that operation or function.

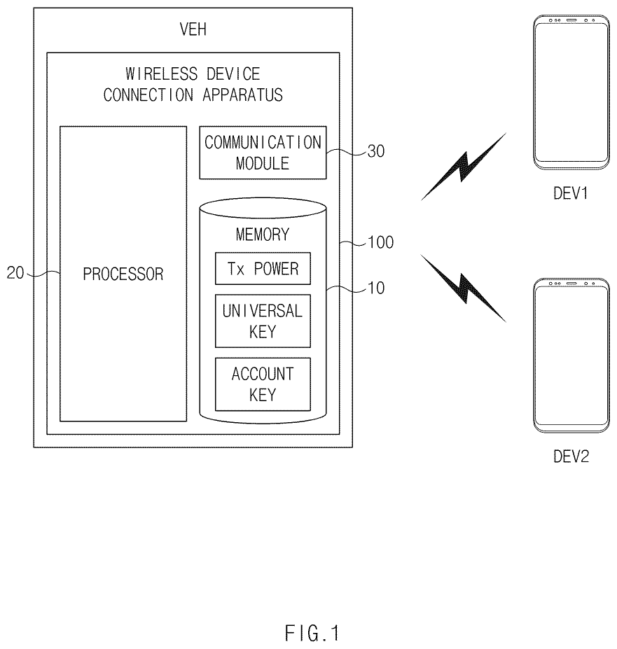

Hereinafter, embodiments of the present disclosure are described in detail with reference to FIGS. 1-12.

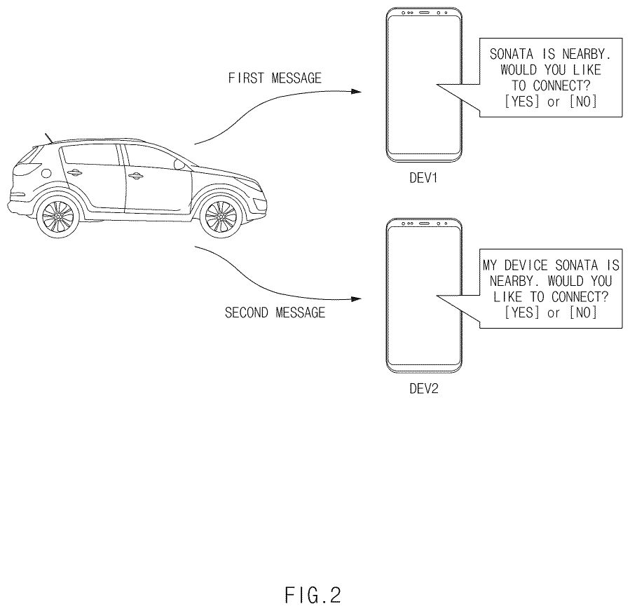

FIG. 1 is a block diagram illustrating a configuration of an apparatus for wireless device connection according to an embodiment of the present disclosure. FIG. 2 is a diagram for describing a broadcasting message according to an embodiment of the present disclosure.

Referring to FIGS. 1 and 2, a wireless device connection apparatus 100 according to an embodiment of the present disclosure may be implemented in a vehicle VEH. The wireless device connection apparatus 100 may be for connecting the vehicle VEH with nearby devices DEV1 and DEV2 located adjacent to the vehicle VEH. The nearby devices DEV1 and DEV2 may be various devices (e.g., short-range wireless devices) that include electronic control and communication circuitry capable of wirelessly communicating with the vehicle VEH.

The wireless device connection apparatus 100 may include a memory 10, a processor 20, and a communication module 30.

The memory 10 may store transmission power (hereinafter referred to as Tx power), universal key information, and account key information. The Tx power, the universal key information, and/or the account information may be included in a broadcasting message broadcast to the nearby devices DEV1 and DEV2.

The Tx power may be information with regard to signal strength of the broadcasting message broadcast through the communication module 30. The Tx power according to an embodiment is distinct from the physical quantity of an actual output signal and may be set separately. The nearby devices DEV1 and DEV2 may calculate a distance from the communication module 30 based on the Tx power information included in the broadcasting message and a received signal sensitivity.

The universal key may be information for identifying the vehicle VEH and may be registered in an operating system (hereinafter referred to as OS) of the nearby devices DEV1 and DEV2.

The account key may be information for distinguishing nearby devices having a history of being paired with an OS account. The account key may include account information of a nearby device, and accordingly, when the broadcasting message including the account key is broadcasted, the nearby device that is to receive the broadcast message may be specified. The account key may be stored in the memory 10 in a form illustrated in Table 1 below.

TABLE 1

| | ACCOUNT | NEARBY DEVICE | ENCRYPTED | PHYSICAL ADDRESS |
|---|---|---|---|---|
| USER | KEY | ACCOUNT (e-mail) | CODE | OF NEARBY DEVICE |
| USER1 | ACCOUNT1 | abd@d.com | A036542 | 12:12:12:12:12:12 |
| | | | | 23:23:23:23:23:23 |
| | . . . | | | |
| | ACCOUNT5 | ABC@a.com | B123457 | 34:34:34:34:34:34 |
| USER2 | ACCOUNT1 | CDE@c.com | C899797 | 56:56:56:56:56:56 |
| | | | | 76:76:76:76:66:56 |
| | . . . | | | |
| | ACCOUNT5 | BNM@d.com | F876544 | 12:34:56:78:90:12 |
| . . . | . . . | | | |

Referring to Table 1, a preset number of account keys (e.g., five account keys) may be assigned to each user. Each account key may include a nearby device account and an encrypted code. The encrypted code may be expressed as an arbitrary value. Also, the account key may include a physical address of a nearby device.

The memory 10 may be included in the processor 20 and/or may be provided separately. Accordingly, the memory 10 may be configured as a combination of a hard disk drive, a flash memory, an electrically erasable programmable read-only memory (EEPROM), a static RAM (SRAM), a ferro-electric RAM (FRAM), a phase-change RAM (PRAM), a magnetic RAM (MRAM), a dynamic random access memory (DRAM), a synchronous dynamic random access memory (SDRAM), a double data rate-SDRAM (DDR-SDRAM), and/or the like.

In addition, the memory 10 may store an algorithm used in a process in which the processor 20 calculates a degree of attenuation. The calculation of the degree of attenuation may be performed based on artificial intelligence. The memory 10 may thus include an artificial intelligence (AI) processor. The AI processor may train a neural network using a pre-stored program. The neural network may be for calculating the degree of attenuation. The neural network may be designed to simulate the structure of the human brain on a computer and may include a plurality of network nodes having weights that simulate neurons of the human neural network. The plurality of network nodes may transmit and receive data according to a connection relationship, respectively, so as to simulate synaptic activity of neurons that transmit and receive signals through synapses. The neural network may include a deep learning model developed from a neural network model. In the deep learning model, a plurality of network nodes may exchange data according to a convolution connection relationship while being located in different layers. Examples of neural network models may include various deep learning techniques such as deep neural networks (DNN), convolutional deep neural networks (CNN), recurrent Boltzmann machine (RNN), restricted Boltzmann machine (RBM), deep trust deep belief networks (DBN), and/or deep Q-networks.

The processor 20 may calculate the degree of attenuation based on the degree of attenuation calculation algorithm. The degree of attenuation may refer to a factor affecting wireless signal reception sensitivity of a nearby device. The processor 20 may adjust the Tx power of a signal transferred to the nearby device through the communication module 30 of the vehicle VEH in proportion to the degree of attenuation. Also, the processor 20 may generate a broadcasting message to include information on the Tx power.

The processor 20 may calculate the degree of attenuation according to the size of the vehicle, the degree to which the interior of the vehicle is opened, and/or the number of passengers. A specific method of calculating the degree of attenuation, according to an embodiment, is described below.

The broadcasting message generated by the processor 20 may include a first message and a second message as illustrated in FIG. 2.

The first message may be generated in response to an operation command in a pairing mode and may include a universal key. The first message may be a broadcasting message used to register a new nearby device (e.g., the nearby device DEV1) to the vehicle VEH.

Discoverable information of the first message may be in an on state. The nearby devices may search for the communication module 30 corresponding to a master by “Discoverable: On”.

Connectable information of the first message may be in an on state. A “Connectable: On” may mean an activation state of the connectable mode. The connectable mode may refer to an operation mode in which the communication module 30 of the vehicle VEH may connect to a nearby device in response to a connection request from the nearby device.

The processor 20 may generate the second message to include the account key matched with operating system (OS) account information of the nearby device in response to a preset condition. The second message may be a message transmitted to a nearby device registered to the vehicle VEH through the communication module 30. The processor 20 may store account information associated with nearby devices connected to the vehicle VEH based on the first message and may generate a second message to include the account information under a specific condition.

In the process of broadcasting the second message using the account key, even if a connection request from the nearby device is received, the processor 20 may continue to broadcast the second message.

When the communication module 30 is attempting automatic connection or is in a pairing mode, broadcasting of the second message may be limited.

Since the second message is a message transmitted to already registered nearby devices, the discoverable information of the second message may be in an off state.

The connectable information of the second message may vary depending on whether the vehicle is in a state in which the vehicle can be connected to an external device. When the vehicle is in a state in which a connection with an external device is possible, the connectable information may be set to an on state. Alternatively, when the vehicle is being connected to an external device, the connectable information may be set to an off state.

The second message may be broadcast after determining whether there is surplus in the number of nearby devices connectable to the vehicle VEH. The number of nearby devices that can be connected may vary depending on the vehicle VEH. The surplus in the number of nearby devices that can be connected may be distinguished by information of “Cmax”. “Cmax” may be divided into “0 (zero)” or “1”. When “Cmax” is “0”, it may mean that there is surplus of connectable nearby devices, and when “Cmax” is “1”, it may mean that there is no surplus of connectable nearby devices. For example, when the number of nearby devices connectable to the vehicle VEH is three, “Cmax” may be “1” while the vehicle VEH is connected to three nearby devices.

Alternatively, when the number of nearby devices connectable to the vehicle VEH is three, “Cmax” may be “0” while the vehicle VEH is connected with two or less nearby devices.

The processor 20 may limit broadcasting of the second message in a state of attempting automatic connection. To this end, the processor 20 may determine whether it is in a state of attempting automatic connection with respect to a nearby device having a pairing history with the vehicle VEH. When the vehicle VEH is in a state of attempting automatic connection, the processor 20 may stop the automatic connection attempt after a period of attempting automatic connection passes a first preset period and may broadcast the second message through the communication module 30.

The processor 20 may broadcast the second message through the communication module 30 based on detecting remote control of the vehicle VEH from a user before the user boards the vehicle VEH.

The communication module 30 may broadcast the first message or the second message under the control of the processor 20. The first message or the second message may include “Device Address” information, “Friendly Name” information, “Discoverable” information, “Connectable” information, “Tx Power” information, and “Device Address2” information. The device address information may be a physical address of a vehicle and may be a fixed address or a virtual address. The friendly name information may be a vehicle name displayed on a nearby device and may be changeable information by a user. The discoverable information may be classified as On or Off and may indicate whether a vehicle may be discovered by a nearby device. The connectable information may be classified as On or Off and may indicate whether wireless connection may be performed according to a request of a nearby device. The Tx Power may be variable and may be determined based on the degree of attenuation. The device adress2 may be a physical address of a nearby device.

The communication module 30 may wirelessly communicate with the nearby devices DEV1 and DEV2 using any radio frequency (RF) or infrared (IR) technology, such as wireless fidelity (Wi-Fi), BLUETOOTH brand communication, near field communication (NFC), radio frequency identification (RFID), and/or others.

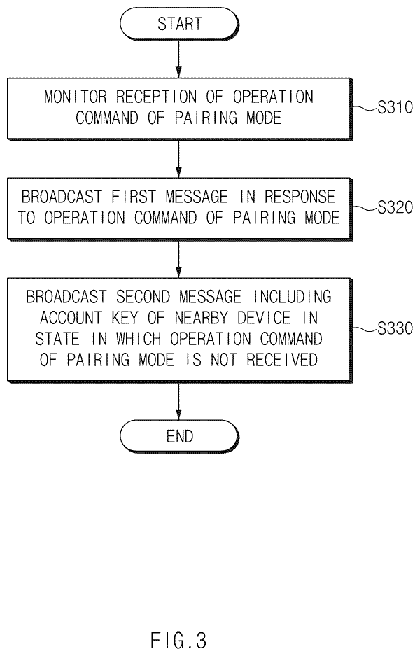

Hereinafter, a wireless device connection method according to an embodiment of the present disclosure is described with reference to FIG. 3. FIG. 3 is a flowchart for describing a wireless device connection method according to an embodiment of the present disclosure.

In an embodiment, operations illustrated in FIG. 3 relate to a connection method between the wireless device connection apparatus 100 illustrated in FIG. 1 and the nearby devices DEV1 and DEV2. The operations illustrated in FIG. 3 may be performed under the control of the processor 20.

Referring to FIG. 3, in operation S310, the processor 20 may monitor reception of operation command of a pairing mode.

In operation S320, the processor 20 may generate a first message to include a universal key in response to receiving the operation command of the pairing mode and may broadcast the first message through the communication module 30.

In operation S330, the processor 20 may generate a second message to include an account key of a nearby device having a pairing history in response to a preset condition when the operation command of the pairing mode is not received and may broadcast the second message through the communication module 30.

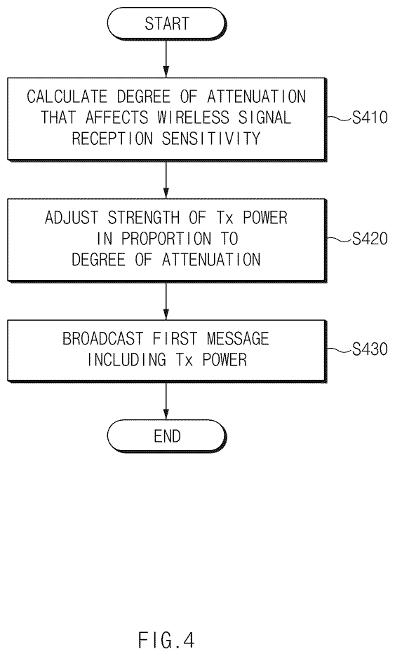

FIG. 4 is a flowchart for describing a wireless device connection method, according to another embodiment of the present disclosure. FIG. 4 is a diagram for describing an embodiment in which the Tx power of a first message or a second message is varied.

Referring to FIG. 4, in operation S410, the processor 20 may calculate a degree of attenuation that affects wireless signal reception sensitivity.

The processor 20 may calculate the degree of attenuation according to the size of the vehicle, the degree to which the interior of the vehicle is opened, and/or the number of passengers. The degree of attenuation may be calculated by adding or subtracting a predetermined determining factor to a basic degree of attenuation.

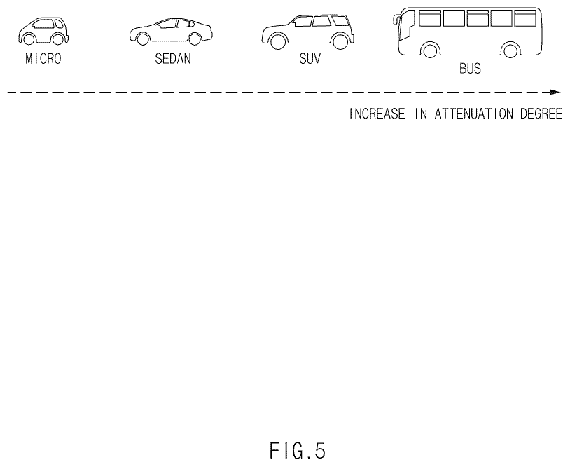

FIGS. 5-7 are diagrams for describing embodiments of calculating a degree of attenuation.

Referring to FIG. 5, the processor 20 may set the degree of attenuation in proportion to the size of the vehicle. The size of the vehicle may be classified into a micro vehicle, a sedan, a sport utility vehicle (SUV), a bus (BUS), and/or the like. The degree of attenuation may be set to a larger value as the size of the vehicle increases. For example, when the vehicle is a sedan, the processor 20 may maintain the basic degree of attenuation. When the vehicle is a micro vehicle, the processor 20 may calculate the degree of attenuation by subtracting a first determination factor from the basic degree of attenuation. When the vehicle is an SUV or a bus, the processor 20 may calculate the degree of attenuation by adding a second determining factor to the basic degree of attenuation.

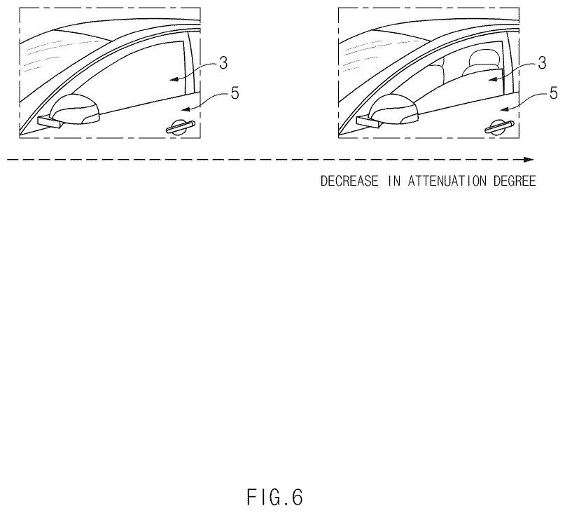

Referring to FIG. 6, the processor 20 may set the degree of attenuation according to a degree of opening of a window 3.

For example, when there is an open window 3, the processor 20 may calculate the attenuation by subtracting a third determining factor from the basic degree of attenuation. The third determining factor may vary according to the degree of opening of the window 3 or the number of opened windows 3.

Similarly, when there is an open door 5, the processor 20 may calculate the degree of attenuation by subtracting a fourth determining factor from the basic degree of attenuation. The fourth determining factor may vary according to the degree of opening of the door 5 or the number of opened doors 5.

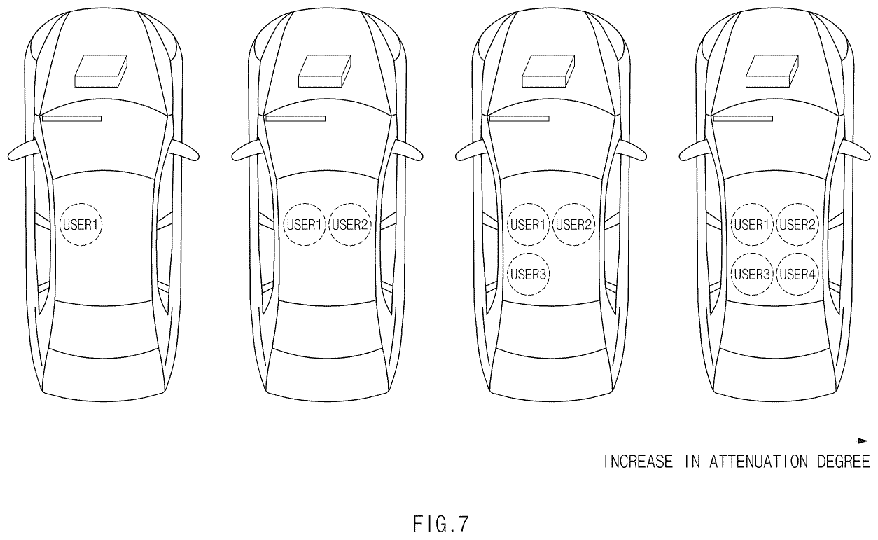

Referring to FIG. 7, the processor 20 may increase the degree of attenuation in proportion to the number of passengers in the vehicle VEH.

The processor 20 may set the size of a fifth determining factor in proportion to the number of passengers. In addition, the processor 20 may determine the degree of attenuation by adding the fifth determining factor to the basic degree of attenuation.

The number of passengers may be determined based on images obtained by a camera, lidar, and/or the like, and/or may be determined using a seating sensor disposed on a seat.

Also, the processor 20 may obtain reliability according to a result of artificial intelligence learning using the size of the vehicle, the degree of opening of the vehicle, and the number of passengers in the vehicle as input values.

Referring back to FIG. 4, in operation S420, the processor 20 may adjust a strength of the Tx power in proportion to the degree of attenuation.

Because the processor 20 adjusts the strength of Tx power based on the degree of attenuation, unintentional wireless connection with nearby devices outside the vehicle may be prevented. For example, when the size of the vehicle is small or the door 5 or the window 3 is opened, the processor 20 may determine the Tx power based on the degree of attenuation set to be less than the basic degree of attenuation. Accordingly, the broadcasting message transmitted from the communication module 30 may not be recognized by the nearby devices outside the vehicle VEH.

As another example, the processor 20 may determine the Tx power based on the degree of attenuation set to be greater than the basic degree of attenuation when the size of the vehicle VEH is large or there is an obstacle to the wireless signal, such as a passenger in the vehicle VEH. Accordingly, it is possible to solve a phenomenon in which a nearby device in the vehicle VEH cannot receive a broadcasting message transmitted from the communication module 30.

As a result, according to various embodiments, by adjusting the strength of the Tx power according to the degree of attenuation, the broadcasting message may not be transmitted to the nearby devices outside the vehicle VEH, but poor reception may be prevented from occurring in the nearby devices located in the vehicle VEH.

In operation S430, the processor 20 may broadcast a first message including information on the Tx power. The first message is for operation in a pairing mode. The first message may be a broadcasting message used to register a new nearby device to the vehicle VEH.

The discoverable information and connectable information of the first message may be in an on state.

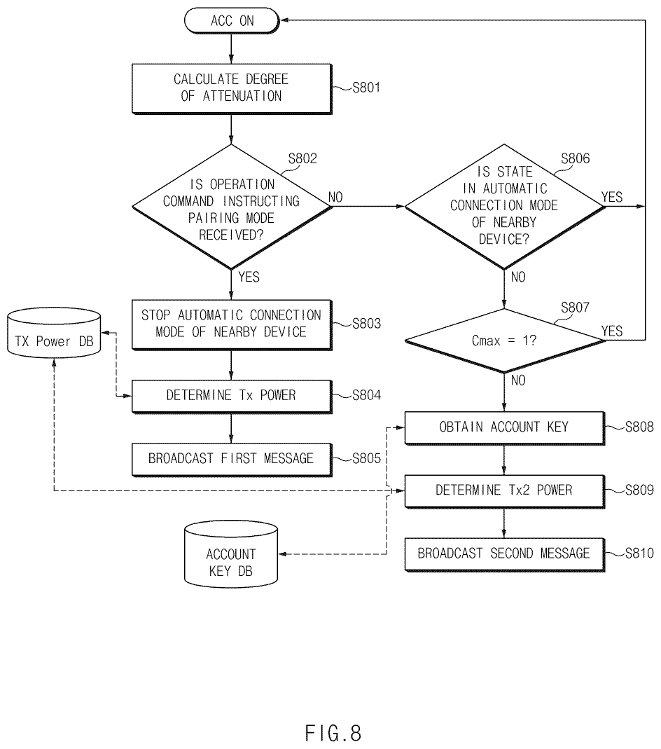

FIG. 8 is a flowchart for describing a wireless device connection method, according to another embodiment of the present disclosure. FIG. 8 is a diagram for describing a method of generating a broadcasting message in a pairing mode and an automatic connection mode.

In operation S801, the processor 20 may calculate a degree of attenuation.

The processor 20 may calculate the degree of attenuation as described above in connection with operation S410 of FIG. 4. For example, the processor 20 may calculate the degree of attenuation based on the size of the vehicle, the degree to which the interior of the vehicle is opened, and/or the number of passengers in the vehicle.

In operation S802, the processor 20 may check whether there is an operation command instructing a pairing mode.

The operation command instructing the pairing mode may be based on a user input. The user input may be transferred through a user interface such as a vehicle cluster.

In operation S803, when there is an operation command instructing the pairing mode, the processor 20 may stop an automatic connection mode of the nearby device.

The automatic connection mode of the nearby device may be an operation mode in which wireless connection is performed targeting the nearby devices registered in the vehicle. The automatic connection mode may be implemented in response to “ACC On” even when a separate user input is not received. For the automatic connection mode, the memory 10 may include link key information indicating a history of connection with the nearby devices. The processor 20 may enter the automatic connection mode in response to “ACC On” and may attempt a wireless connection to the nearby devices corresponding to the link key information.

In operation S804, when the automatic connection mode of the nearby device is stopped, the processor 20 may determine a Tx power.

The processor 20 may determine a strength of the Tx power in proportion to the degree of attenuation.

In operation S805, the processor 20 may generate a first message to include information on the Tx power and may broadcast the first message through the communication module 30.

The processor 20 may generate the first message to include universal key information and may broadcast the first message to perform a procedure for newly registering an unregistered nearby device with respect to the vehicle VEH.

In operation S806, when an operation command instructing a pairing mode is not received, the processor 20 may determine whether the communication module 30 is in an automatic connection mode of the nearby device. In an example, when there is no user input requesting the pairing mode, the processor 20 may enter the automatic connection mode of the nearby device in response to the ACC On.

When the communication module 30 is in the automatic connection mode, the processor 20 may return to an initial procedure of checking ACC On so as to monitor a user input instructing to enter the pairing mode.

In operation S807, when the communication module 30 is not in the automatic connection mode of the nearby device, the processor 20 may determine whether the Cmax information is “1”.

In operation S808, the processor 20 may obtain an account key when the Cmax information is “1”. In other words, when there is surplus in the number of the nearby devices connectable to the vehicle VEH, the processor 20 may obtain the account key.

At operation S809, the processor 20 may determine a Tx power.

The processor 20 may determine a strength of the Tx power in proportion to the degree of attenuation.

In operation S810, the processor 20 may generate a second message to include the account key obtained in operation S708 and the Tx power determined in operation S709 and may broadcast the second message through the communication module 30.

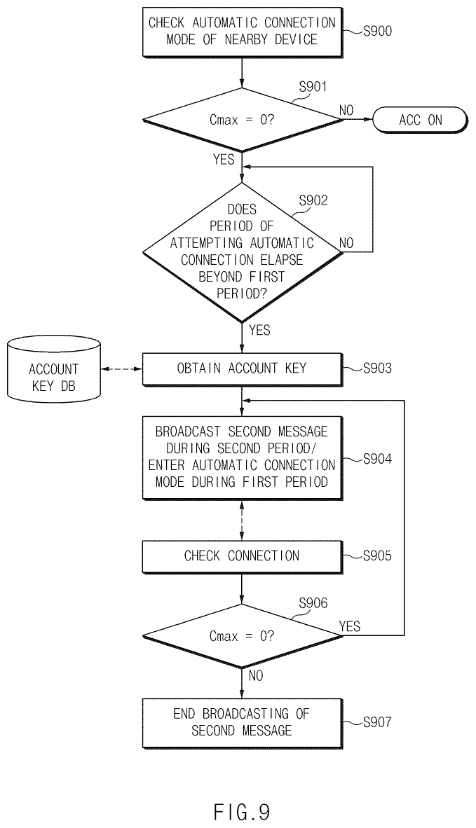

FIG. 9 is a flowchart for describing a wireless device connection method according to another embodiment of the present disclosure. FIG. 9 is a diagram for describing a method of broadcasting a second message in an automatic connection mode.

Procedures illustrated in FIG. 9 may proceed based on the fact that the processor 20 checks the automatic connection mode of the nearby device in operation S900. Operation S900 may be a procedure determined according to the determination result of operation S806 illustrated in FIG. 8.

In operation S901, the processor 20 may determine whether the Cmax information is “0 (zero)”. When the Cmax information is not “0”, i.e., when the Cmax information is “1”, the processor 20 may return to an initial state responding to the ACC On.

In operation S902, when the Cmax information is “0”, the processor 20 may determine whether the period of attempting automatic connection elapses beyond a first period. The first period may be set in advance. The first period may be, for example, within 10 minutes.

In operation S903, when the period of attempting automatic connection elapses beyond the first period, the processor 20 may obtain the account key from the memory 10.

The operation S903 may be performed when the target nearby device to which the vehicle VEH attempts the automatic connection is not present in the vehicle VEH, or vehicle information is deleted from the target nearby device. When the vehicle information is deleted from the target nearby device, the wireless connection with the target nearby device cannot be established even if the vehicle VEH attempts the automatic connection. The processor 20 may prepare to broadcast the second message through operation S903 to perform the wireless connection with the target nearby device from which the vehicle information is deleted.

In operation S904, the processor 20 may generate the second message to include the account key and may broadcast the second message through the communication module 30 during a second period.

As illustrated in Table 1, the account key of the second message may include a physical address matched with a user account registered in the vehicle VEH.

Also, the second message may include information of Discoverable: Off and information of Connectable: On.

Even when the vehicle information is deleted from the nearby device, as illustrated in FIG. 2, the wireless connection request may be provided to the nearby device corresponding to the physical address through the second message.

In operation S905, the processor 20 may determine whether the connection with the nearby device succeeds.

The connection between the communication module 30 and the nearby device may be completed based on a user input of the nearby device. The nearby device for which the wireless connection request is displayed based on the second message may display a user interface for wireless connection approval. The processor 20 may thus determine whether there is approval for a wireless connection through a user interface of a nearby device.

In operation S906, the processor 20 may determine whether the Cmax information is “0” after determining that the nearby device is wirelessly connected. The processor 20 may thus determine whether there is surplus in the number of nearby devices connectable to the vehicle VEH. When there is a number of nearby devices connectable to the vehicle VEH, the processor 20 may return to operation S804 and may repeat broadcasting of the second message for additional nearby device connection.

In operation S907, when there is no surplus in the number of connectable nearby devices, the processor 20 may end the procedure of broadcasting the second message.

Through the embodiment illustrated in FIG. 9, even if vehicle information is deleted from the wireless connection list of nearby devices, the wireless connection request may be displayed on the target nearby device using the account key, so that the wireless connection between the vehicle and the nearby device may be performed.

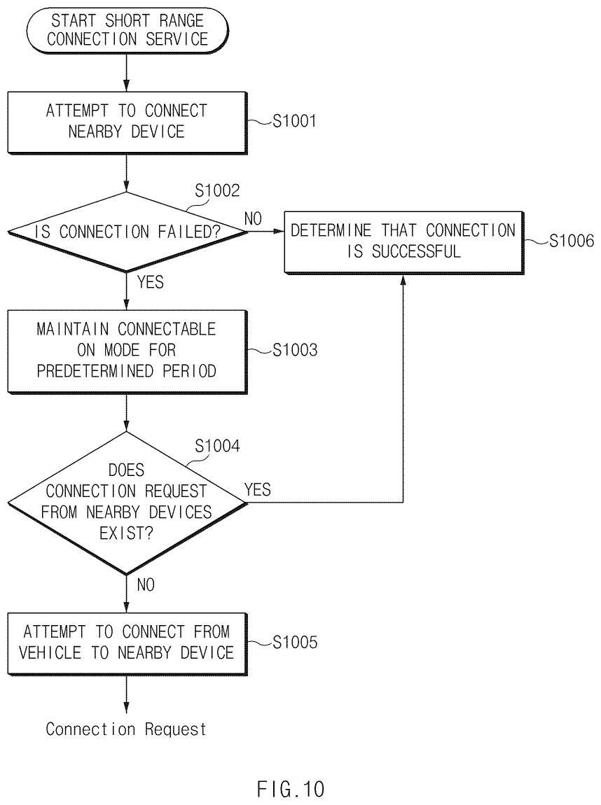

FIG. 10 is a flowchart for describing a wireless device connection method according to another embodiment of the present disclosure. FIG. 10 is a diagram for describing an embodiment of performing a recovery procedure in response to a wireless connection failure.

Referring to FIG. 10, in operation S1001, the processor 20 may attempt to connect a nearby device to the vehicle VEH.

In operation S1002, the processor 20 may determine whether the connection between the vehicle VEH and the nearby device is failed.

In operation S1003, in response to the failure of connection between the vehicle VEH and the nearby device, the processor 20 may maintain the Connectable On mode for a predetermined period. When the state is in the Connectable Off mode before operation S1003, the processor 20 may perform a procedure for changing the Connectable Off mode to the Connectable On mode. The predetermined period may be set in advance and may be within a range in which wireless connection with a nearby device according to a subsequent procedure is possible. In an example, the predetermined period may be set to 2 seconds.

In operation S1004, the processor 20 may monitor whether there is a connection request from the nearby devices in the Connectable On mode.

In operation S1005, when there is no connection request from the nearby devices, the processor 20 may attempt to connect to the nearby device. To this end, the processor 20 may broadcast the connection request message. The connection request message may include address information of the vehicle. Information with regard to the vehicle transmitting the connection request message may thus be provided to nearby devices.

In operation S1006, the processor 20 may terminate the wireless connection service based on a successful connection.

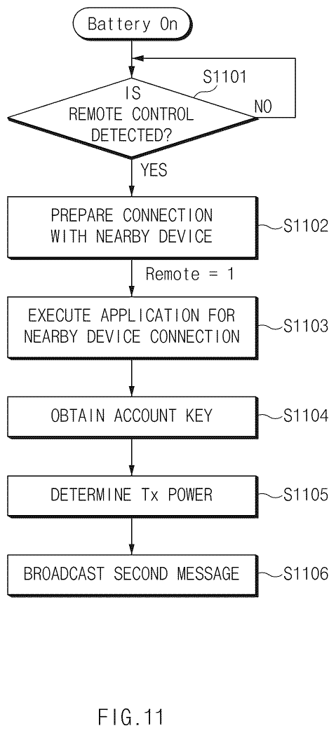

FIG. 11 is a flowchart for describing a wireless device connection method, according to another embodiment of the present disclosure. FIG. 11 is a diagram for describing a procedure for attempting a wireless device connection in response to a remote control.

Referring to FIG. 11, in operation S1101, the processor 20 may detect a remote control while a battery is on.

When an engine of the vehicle VEH is remotely turned on or the door is remotely opened, the wireless device connection apparatus 100 may be booted.

Because the automatic connection operation of the nearby device may proceed in the ACC On state, the automatic connection operation of the nearby device may be limited in operation S1101. The wireless device connection apparatus 100 is booted by the remote control because it is in a background booting state. The following procedure may be performed to compensate for the automatic connection operation illustrated in FIGS. 8 and 9 being limited.

In operations S1102 and S1103, the processor 20 may prepare the connection with the nearby device and may execute an application for a nearby device connection. The application for the nearby device connection may be stored in the memory 10 and may be a component included in a function of the processor 20.

In operation S1104, the processor 20 may obtain the account key of the user who instructs the remote control.

The processor 20 may identify the owner of the smart key based on identification information of the smart key that transmits the remote control command. As illustrated in Table 1, the processor 20 may search for the owner account of the smart key from a recorded user account of the vehicle. The processor 20 may obtain account key information that matches the account of the owner of the smart key.

In operation S1105, the processor 20 may determine a Tx power. The processor 20 may calculate a degree of attenuation based on the procedure illustrated in FIG. 4 and calculate the Tx power based on the degree of attenuation.

In operation S1106, the processor 20 may generate a second message to include the account key information and the Tx power information and may broadcast the second message through the communication module 30.

As illustrated in FIG. 11, according to an embodiment of the present disclosure, the wireless connection procedure of the nearby device may be performed in a background booting state by the remote control. Therefore, since the nearby device may be wirelessly connected in the background booting state by the remote control even before the ignition of the vehicle is turned on, the wireless connection with the nearby device may be performed more quickly.

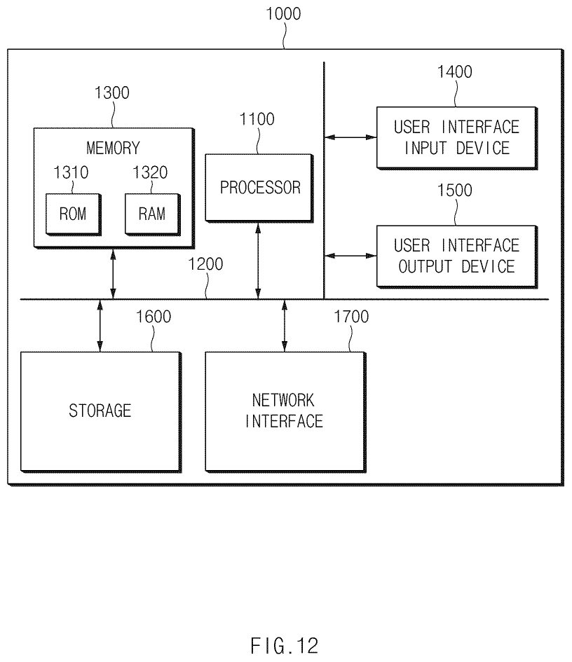

FIG. 12 illustrates a computing system according to an embodiment of the present disclosure.

Referring to FIG. 12, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The processor 1100 may be a configuration including a function of the processor 20 illustrated in FIG. 1. Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information into the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to an embodiment of the present disclosure, because the vehicle adjusts a strength of the transmission power of a broadcasting message requesting the wireless connection, poor reception of a nearby device in the vehicle may be prevented while also preventing the vehicle from wirelessly connecting with an unintended nearby device.

In addition, according to an embodiment of the present disclosure, a vehicle and nearby device may be wirelessly connected more efficiently by transmitting a broadcasting message including an account key according to preset conditions in a non-pairing mode.

In addition, according to an embodiment of the present disclosure, when there is a wireless connection failure, the vehicle may perform a wireless connection in response to a wireless connection request from a nearby device based on a recovery procedure.

In addition, according to an embodiment of the present disclosure, because a wireless connection may be performed in response to a remote control even before a user gets into a vehicle, it is possible to connect the vehicle and the nearby device more quickly.

In addition to this, various effects identified directly or indirectly through this specification may be provided.

The above description is merely illustrative of the technical idea of the present disclosure. Those of ordinary skill in the art to which the present disclosure pertains should be able to make various modifications and variations without departing from the essential characteristics of the present disclosure.

Therefore, embodiments of the present disclosure are not intended to limit the technical spirit of the present disclosure but provided only for the illustrative purpose. The scope of protection of the present disclosure should be construed by the attached claims, and all equivalents thereof should be construed as being included within the scope of the present disclosure.

What is claimed is:

1. An apparatus for nearby wireless device connection, the apparatus comprising:
a memory configured to store information of a nearby device having a pairing history;
a processor configured to
monitor reception of a pairing mode operation command,
generate a first message to include a universal key in response to receiving the pairing mode operation command, and
generate a second message to include an account key of the nearby device having the pairing history when the pairing mode operation command is not received; and
a communication module configured to broadcast the first message or the second message under control of the processor.

2. The apparatus of claim 1, wherein the processor is configured to control the communication module to transmit a physical address of the nearby device having the pairing history associated with an account of an operating system of the nearby device.

3. The apparatus of claim 2, wherein the processor is configured to:
determine that an automatic connection attempt is performed with respect to the nearby device; and
stop the automatic connection attempt and generate the second message after a period of attempting the automatic connection elapses beyond a preset first period.

4. The apparatus of claim 3, wherein the processor is configured to generate the second message after determining whether there is an excess of a number of nearby devices that can be connected to a vehicle.

5. The apparatus of claim 1, wherein the processor is configured to generate the second message based on detecting a remote control of a vehicle from a user before the user boards the vehicle.

6. The apparatus of claim 1, wherein the processor is configured to:
perform an operation in a connectable-on mode capable of responding to a connection request from the nearby device when connection with the nearby device fails; and
attempt to directly connect to the nearby device based on an address of the nearby device when there is no connection request from the nearby device for a preset second period.

7. The apparatus of claim 1, wherein the processor is configured to:
calculate a degree of attenuation based on an attenuation calculation algorithm;
adjust a Tx power of a signal transferred to the nearby device through a communication module of a vehicle in proportion to the degree of attenuation; and
include information on the Tx power in the first message or the second message.

8. The apparatus of claim 7, wherein the processor is configured to adjust the degree of attenuation based on a size of the vehicle.

9. The apparatus of claim 7, wherein the processor is configured to adjust the degree of attenuation based on a degree of opening of an interior of the vehicle.

10. The apparatus of claim 7, wherein the processor is configured to adjust the degree of attenuation based on a number of passengers in the vehicle.

11. A method of nearby wireless device connection, the method comprising:
monitoring reception of an operation command in a pairing mode;
broadcasting a first message including a universal key in response to receiving the operation command in the pairing mode; and
broadcasting a second message including an account key of a nearby device having a pairing history when the operation command in the pairing mode is not received.

12. The method of claim 11, wherein broadcasting the second message further includes:
transmitting a physical address of the nearby device having the pairing history associated with an account of an operating system of the nearby device.

13. The method of claim 12, wherein broadcasting the second message includes:
determining that an automatic connection attempt is being performed with respect to the nearby device; and
stopping the automatic connection attempt and broadcasting the second message after a period of attempting the automatic connection elapses beyond a preset first period.

14. The method of claim 13, wherein broadcasting the second message further includes:
determining whether there is an excess of a number of nearby devices that can be connected to a vehicle.

15. The method of claim 11, wherein broadcasting the second message is performed based on detecting a remote control of a vehicle from a user before the user boards the vehicle.

16. The method of claim 11, wherein broadcasting the first message or broadcasting the second message further includes:
performing an operation in a connectable-on mode capable of responding to a connection request from the nearby device when connection with the nearby device fails; and
attempting to directly connect to the nearby device based on an address of the nearby device when there is no connection request from the nearby device for a preset second period.

17. The method of claim 11, wherein broadcasting the first message or broadcasting the second message further includes:
calculating an attenuation degree affecting wireless signal reception sensitivity of the nearby device;
adjusting a Tx power of a signal transferred to the nearby device through a communication module of a vehicle in proportion to the attenuation degree; and
generating the first message or the second message to further include information on the Tx power.

18. The method of claim 17, wherein calculating the attenuation degree includes adjusting the attenuation degree based on a size of the vehicle.

19. The method of claim 17, wherein calculating the attenuation degree includes adjusting the attenuation degree based on a degree of opening of an interior of the vehicle.

20. The method of claim 17, wherein calculating the attenuation degree includes adjusting the attenuation degree based on a number of passengers in the vehicle.
